(19) United States
(12) Patent Application Publication
(10) Pub. No.: US 2003/0175575 A1
(43) Pub. Date: Sep. 18, 2003

(54) PEM fuel cell stack and method of making same

(75) Inventors: Ralf Zuber, Grossostheim (DE); Armin Bayer, Freigericht (DE); Heike Kuhnhold, Bruchkobel (DE); Holger Dzallas, Ense (DE); Marc Daurer, Seeheim-Jugenheim (DE)

Correspondence Address: KALOW & SPRINGUT LLP, 488 MADISON AVENUE, 19TH FLOOR, NEW YORK, NY, 10022, US

(73) Assignee: OMG AG & Co. KG, Hanau (DE)

(21) Appl. No.: 10/368,884

(22) Filed: Feb. 19, 2003

(30) Foreign Application Priority Data
Feb. 28, 2002 (EP) 02004599.3

(51) Int. Cl. H01M 8/02; H01M 2/08; B60L 11/18; H01M 8/10

(52) U.S. Cl. 429/35; 429/38; 429/32; 180/65.3

(57) ABSTRACT

The invention herein relates to a PEM fuel cell stack consisting of one or more superimposed fuel cells (1), each containing a membrane electrode assembly (2) and electrically conductive bipolar plates (3, 4), whereby the membrane electrode assemblies each comprise a polymer electrolyte membrane (5), which is in contact on each side with a reaction layer (6, 7); whereby the reaction layers cover a smaller area than the polymer electrolyte membrane, and between each reaction layer and the adjacent bipolar plates—essentially congruent with the reaction layers—respectively one compressible gas distribution layer (8, 9) of carbon fiber material is provided, and gaskets (11, 12) are interposed in the region outside the area covered by the gas distribution layers; whereby the gas diffusion electrodes formed by the reaction layers and the gas distribution layers exhibit a no-load thickness of D₁ and the gaskets a thickness D₂. The PEM fuel cell stack is characterized in that the gas diffusion electrodes in the PEM fuel stack are compressed to 50% to 85% of their original thickness (compression factor k=0.5 to 0.85).

### FIELD OF THE INVENTION

The invention herein relates to a PEM fuel cell stack of superimposed membrane electrode assemblies, gas distribution layers and bipolar plates. In particular, the invention herein relates to the type of PEM fuel cell stacks that contain gas distribution layers of carbon fiber material (“nonwovens”).

### BACKGROUND OF THE INVENTION

Fuel cells use two spatially separated electrodes for the conversion of fuel and an oxidizing agent into electric current, heat and water. In doing so, hydrogen or a hydrogen-rich gas can be used as the fuel, and oxygen or air can be used as the oxidizing agent. The process of energy conversion in the fuel cell is characterized by a particularly high degree of efficiency. It is for this reason, that fuel cells, in combination with electric motors, are becoming increasingly important as an alternative to conventional internal combustion engines.

Due to its compact design, its power density, as well as its high degree of efficiency, the so-called polymer electrolyte fuel cell (PEM fuel cell) is suitable for use as an energy converter in electrically powered automobiles.

Within the scope of the invention herein, a PEM fuel cell stack is understood to be the stack-like arrangement (“stack”) of fuel cell units. Hereinafter, a fuel cell unit is simply called a fuel cell. Each fuel cell contains a membrane electrode assembly (MEA) interposed between two bipolar plates—also called separator plates—for gas supply and current conduction. One membrane electrode assembly consists of a polymer electrolyte membrane that is provided with reaction layers on both its sides. One of said reaction layers is configured as an anode for the oxidation of hydrogen and the second reaction layer is configured as a cathode for the reduction of oxygen. So-called gas distribution layers of carbon fiber fleece material, carbon fiber paper or carbon fiber fabric are placed on the reaction layers, whereby said gas distribution layers provide good access of the reaction gases to the electrodes and good discharge of the electric current of the cell. The two-layer combination of reaction layer and gas distribution layer is also called a gas diffusion electrode. The anode and cathode contain so-called electrocatalysts, which provide catalytic support for the respective reaction (oxidation of hydrogen or reduction of oxygen). Preferably used as catalytically active components are the metals of the platinum group of The Periodic Table of the Elements. Most frequently used are the so-called supported catalysts, in which case the catalytically active metals of the platinum group are applied, in highly disperse form, to the surface of a conductive support material. In this case, the mean crystallite size of the metals of the platinum group ranges between approximately 1 and 10 nm. Finely divided carbon black particles have been found to be effective as support materials.

The polymer electrolyte membrane consists of proton-conducting polymer materials. Hereinafter, these materials will also be simply called ionomers. Preferably, a tetrafluoroethylene-fluorovinyl ether copolymer having acid functions, specifically sulfonic acid groups, is used. Such a material is marketed by E. I. DuPont under the trade name of Nafion®, for example. However, there are other materials, in particular, ionomer materials such as fluorine-free ionomer materials, sulfonated polyetherketones, or arylketones or polybenzimidazoles.

For widespread commercial use of PEM fuel cells in automobiles, and stationary applications (such as combined heat and power supply for residential houses), however, further improvements of the electrochemical cell performance, as well as a significant reduction of the system's costs, are required.

One essential prerequisite for increasing cell performance is an optimal supply and discharge of the respective reactive gas mixtures to and from the catalytically active centers of the catalyst layers. In addition to the supply of hydrogen to the anode, the ionomer material of the anode must be humidified continuously with water vapor (humidification water) in order to ensure optimal proton conductivity. Water (reaction water) forming on the cathode must be removed continuously in order to prevent flooding of the pore system of the cathode and the resultant impairment of the oxygen supply.

U.S. Pat. No. 4,293,396 describes a gas diffusion electrode, which consists of an open-pore conductive carbon fiber fabric. The pores of the carbon fiber fabric contain a homogeneous mixture of catalyzed carbon particles (carbon particles that are coated with catalytically active components) and hydrophobic particles of a binder material.

EP 0 869 568 A1 describes a gas distribution layer consisting of a carbon fiber fabric for membrane electrode units. In order to improve the electrical contact between the catalyst layers of the membrane electrode units and the carbon fiber fabric of the gas distribution layers, the carbon fiber fabric is coated, on the side facing the respective catalyst layer, with a micro layer of carbon and a fluorine polymer, whereby said micro layer is porous and water-repellent and, at the same time, electrically conductive and, furthermore, has a relatively smooth surface. Preferably, this micro layer does not penetrate through more than half of the carbon fiber fabric. In order to enhance its water-repelling properties, the carbon fiber fabric may be pre-treated with a mixture of carbon and a fluorine polymer.

WO 97/13287 describes a gas distribution layer (here “intermediate layer”), which can be obtained by infiltrating and/or coating one side of a large-pore carbon substrate (carbon paper, graphite paper or carbon felt material) with a composition of carbon and a fluorine polymer that reduces the porosity of the part of the carbon substrate close to the surface and/or forms a discreet layer of reduced porosity on the surface of the substrate. The coated side of the gas distribution layer is placed on the catalyst layers of the membrane electrode units. In this way, the coating solves the problem of establishing a good electrical contact with the catalyst layers, as is the case, among other things, in the disclosure of EP 0 869 568.

The coating of the gas distribution layers as disclosed by WO 97/13287, U.S. Pat. No. 4,293,396, DE 195 44 323 A1 and EP 0 869 568 with a mixture of carbon and PTFE is complex and requires a final drying step and calcination at 330° C. to 400° C.

U.S. Pat. No. 6,007,933 describes a fuel cell unit of stacked membrane electrode assemblies and bipolar plates. Elastic gas distribution layers are arranged between the membrane electrode assemblies and the bipolar plates. In order to supply the membrane electrode assemblies with reactive gases, the bipolar plates have gas distribution channels—which are open on one side—on their contact surfaces facing the gas distribution layers. In order to improve the electrical contact between the gas distribution layers and the membrane electrode assemblies, the fuel cell unit is assembled under pressure. While doing so, there is the risk that the elastic gas distribution layers penetrate into the one open side of the gas distribution channels and thus block the transport of gas and impair the electrical performance of the fuel cell. In U.S. Pat. No. 6,007,933, for example, this is prevented by perforated metal sheets that are interposed between the gas distribution layers and the bipolar plates. In order to seal the membrane electrode units, O-ring gaskets and gaskets of PTFE films are used.

Lee et al. (Lee et al., “The effects of compression and gas diffusion layers on the performance of a PEM fuel cell;” Journal of Power Sources 84 (1999), 45 to 51) investigated how the use of compressive pressure during assembly of the fuel cells affects the performance of fuel cells. The gas distribution layers used were stiff carbon fiber papers by Toray, as well as CARBEL® and ELAT® carbon fiber fabrics. When the compressive pressure is too high, the carbon fiber paper by Toray breaks and, consequently, is not very suitable. The said carbon fiber fabrics are commercially available products, each being provided with a micro layer.

The problem to be solved by the invention herein is to provide a fuel cell stack, which, compared with prior art, features a simpler design and, at the same time, exhibits better electrical performance. A further problem to be solved by the invention herein is to provide gas distribution layers suitable therefor.

### SUMMARY OF THE INVENTION

In one embodiment, the invention comprises a PEM fuel cell stack of one or more superimposed fuel cells (1), each containing a membrane electrode assembly (2) and electrically conductive bipolar plates (3,4), whereby each of said membrane electrode assemblies comprises a polymer electrolyte membrane (5), which, on each side, is in contact with a reaction layer (6,7); whereby the reaction layers cover a smaller area than the polymer electrolyte membrane, and whereby, between each reaction layer and the adjacent bipolar plates, one compressible gas distribution layer (8, 9) of carbon fiber material is arranged substantially congruent with the reaction layers; and whereby, in the region outside the area covered by the gas distribution layers, gaskets (11, 12) are interposed; whereby the gas diffusion electrodes formed by the reaction layers and the gas distribution layers exhibit a no-load thickness D₁ and the gaskets exhibit a no-load thickness D₂. The PEM fuel cell stack is characterized in that the gas diffusion electrodes in the PEM fuel cell stack are compressed to 50% to 85% of their original thickness (compression factor k=0.5 to 0.85).

In another embodiment, the invention comprises a PEM fuel cell stack, having one or more superimposed fuel cells wherein each fuel cell comprises: (a) a membrane electrode assembly having a polymer electrolyte membrane; (b) a reaction layer on each side of the polymer electrolyte membrane, wherein each reaction layer covers a smaller area than the polymer electrolyte membrane; (c) a compressible, large-pore gas distribution layer of carbon fiber material adjacent to each reaction layer and substantially congruent thereto, wherein each gas distribution layer has a first side and a second side, and wherein the first side is in direct contact with the reaction layer; (d) an electrically conductive bipolar plate adjacent to each second side of each gas distribution layer and each plate covering an area larger than the adjacent gas distribution layer; and, (e) gaskets disposed between each bipolar plate and the polymer electrolyte membrane outside the area covered by the gas distribution layers; wherein gas diffusion electrodes formed by the reaction layers and the gas distribution layers exhibit a no-load thickness D1 and when in the PEM fuel cell stack are compressed to a thickness D2, wherein D2 is equal to the thickness of each gasket, and D2 is 50% to 85% of D1.

In another embodiment, the invention includes a fuel cell comprising: (a) a polymer electrolyte membrane; (b) a reaction layer on each side of the polymer electrolyte membrane, wherein each reaction layer has length and width dimensions smaller than those of the polymer electrolyte membrane; (c) at least one compressible, large pore gas distribution layer of carbon fiber material adjacent to and substantially congruent with one of the reaction layers, wherein the gas distribution layer has a first face and a second face and wherein the first face of the gas distribution layer is in direct contact with the adjacent reaction layer; (d) at least one electrically conductive bipolar plate in direct contact with the second face of the gas distribution layer; and (e) a gasket having a thickness D2 and disposed between the bipolar plate and the polymer electrolyte membrane; wherein the gas distribution layer and the adjacent reaction layer together have a no-load thickness of D1 and are capable of being compressed to thickness D2 and D2 is 50% to 85% of D1.

In another embodiment, the invention comprises a method of making a fuel cell stack using fuel cells of the invention, comprised of: stacking the fuel cells; and compressing the gas diffusion electrodes in the fuel cell stack to the thickness of the gaskets.

In another embodiment, the invention comprises a gas distribution layer for PEM fuel cell stacks, comprised of: a gas distribution layer having a compressible, large-pore carbon fiber material that is compressed in the fuel cell stack to 50% to 85% of its original thickness.

The invention also includes electrically powered automobiles having a fuel cell unit or fuel cell stack in accordance with the invention for the supply of electrical energy, or a fuel cell stack or fuel cell unit manufactured in accordance with the inventive methods.

The invention also includes a combined heat and power supply for residential houses, having a fuel cell unit for the supply of electrical energy and heat, comprised of a fuel cell unit comprising a PEM fuel cell stack in accordance with the invention.

For a better understanding of the present invention together with other and further advantages and embodiments, reference is made to the following description taken in conjunction with the examples, the scope of the which is set forth in the appended claims.

### BRIEF DESCRIPTION OF THE DRAWINGS

The preferred embodiments of the invention have been chosen for purposes of illustration and description but are not intended to restrict the scope of the invention in any way. The preferred embodiments of certain aspects of the invention are shown in the accompanying figures, wherein:

The following examples explain the essence of the invention herein with reference to drawings. They show:

FIG. 1A cross-section of a fuel cell unit, which contains a membrane electrode assembly.

FIG. 2A plan view of a bipolar plate with a superimposed gas distribution layer and a gasket.

FIG. 3 Cell voltage as a function of the current density during reformate/air operation for the MEA of Example 2, Reference Example 1 and Reference Example 2.

FIG. 4 Cell voltage as a function of the current density during reformate/air operation for the MEA of Example 1, Example 2, Example 3, and Reference Examples 3 and 4.

### DETAILED DESCRIPTION OF THE PREFERRED EMBODIMENTS

The present invention will now be described in connection with preferred embodiments. These embodiments are presented to aid in an understanding of the present invention and are not intended to, and should not be construed, to limit the invention in any way. All alternatives, modifications and equivalents that may become obvious to those of ordinary skill upon reading the disclosure are included within the sprit and scope of the present invention.

This disclosure is not a primer on preparing PEM fuel cell stacks; basic concepts known to those skilled in the art have not been set forth in detail.

In accordance with the invention herein, the gas diffusion electrodes of the fuel cells are compressed to 50% to 85%, preferably to 60% to 70% of their original thickness during assembly. The thickness D₁ of one gas diffusion electrode is composed of the combined thickness of the gas distribution layer and the reaction layer. Due to the greater thickness of the gas distribution layer (approximately 200 to 400 μm) and, as a rule, its greater compressibility, the lion's share of compression is borne by the gas distribution layer.

The compression factor k as defined herein describes the reduction of the thickness of the gas diffusion electrodes to a specific value by means of compression. The smaller the compression factor k is, the greater the compression of the gas diffusion electrodes needs to be during assembly of the fuel cell stack. When k=0.5, the gas diffusion electrodes must be compressed to half of their no-load thickness D₁.

The adjustment of a defined compression factor k for the gas diffusion electrodes in a fuel cell stack ensures, due to the factor's upper limit of at most 0.85, a still sufficient electrical contact between the reaction layer and the gas distribution layer. Due to the specified lower limit of 0.5, preferably 0.6, it becomes impossible for the carbon fibers of the gas distribution layer to puncture the polymer electrode membrane due to excessive compression (pinhole formation), which would impair the performance of the fuel cell or even render it completely useless.

At the punctured sites (pinholes) the hydrogen can move directly from the anode to the cathode and react there with the oxygen. This results in a local development of thermal energy, so-called hot spots. The onset of such damage can be recognized by the drop of the open cell voltage to below 900 mV (without electrical load) during reformate operation or 930 mV during hydrogen operation. The pinholes, or the thin areas of the membrane, will enlarge when heat develops and lead to the total failure of the affected cell.

Due to the specified compression of the gas diffusion electrodes, the porosity of the gas distribution layers is reduced to 50% to 85% and 60% to 70% of their original porosity, so that a flooding of the pores by reaction water is prevented. This leads to a considerable improvement of the electrical performance of the fuel cell stack. However, excessive compression with a compression factor lower than 0.5 has a negative effect on the gas-transporting properties of the gas distribution layers and reduces performance in the range of high current densities.

It has been found that with the proper selection of the compression factor, a coating of the gas distribution layer with a so-called micro layer of carbon and a hydrophobic polymer can be omitted. This micro layer in known fuel cell stacks has the task of creating a good contact between the reaction layer and the gas distribution layer on one hand and of smoothing the surface of the gas distribution layer and preventing a puncturing of the polymer electrolyte membrane by the fibers of the carbon fiber material on the other hand. By omitting the micro layers and simultaneous appropriate compression of the fuel cell stacks, cell performance can be distinctly improved compared with conventionally constructed fuel cell stacks. Thus, the sides of the gas distribution layers facing the reaction layers are in direct contact with the reaction layers. The compression factor that is suitable for this purpose ranges between 0.5 and 0.85, preferably between 0.6 and 0.7.

The defined compression can be adjusted in a simple manner by using gaskets of incompressible material having a thickness D₂ that is smaller than the thickness D₁ of the compressible gas diffusion electrodes (with no load). During the assembly of the fuel cell stack the compressible gas diffusion electrodes are compressed to the thickness of the gaskets so that a compression factor of k=D₂/D₁ results for the compression of the gas diffusion electrodes. Within the scope of this invention, materials or material laminates exhibiting a compressibility of less than 5%, preferably less than 1%, of the compressibility of the gas distribution layers are considered incompressible. Preferably, gaskets of polytetrafluoroethylene (PTFE) are used, which, when reinforced with glass fibers, satisfy the above-described requirements. However, various gasket materials can be applied.

By using incompressible gaskets, the assembly of the fuel cell stack becomes very simple and permits the accurate and reproducible adjustment of compression factor k, because the gas diffusion electrodes merely need to be compressed to the thickness of the incompressible gaskets. An exact adjustment of the compressive pressure is not necessary.

Incompressible gaskets may be obtained in various thicknesses. On occasion, a gasket having the appropriate thickness for adjusting a certain compression factor may not be available. In this case a precise, or at least almost precise adjustment of the desired thickness of the gasket is possible by combining a thicker and a thinner gasket. The gaskets on the cathode side and on the anode side then have different layer thicknesses D_{Cathode} (D_{C}) and D_{Anode} (D_{A}). The compression factor of the gas diffusion electrodes is then expressed as k=(D_{A}+D_{C})/2D₁. It is also possible to achieve a desired gasket thickness by stacking two or more gaskets.

As has already been explained, it is particularly advantageous that the otherwise usual application of an electrically conductive micro layer to the gas distribution layers, and consequently related expensive process steps, can be avoided due to the defined compression of the gas distribution layers. In addition, special metal support sheets, which are intended to prevent penetration of the carbon fiber material of the gas distribution layers into the flow channels of the bipolar plates, can be omitted.

The inventive PEM fuel cell stacks permit good access of the reactive gases to the catalytically active centers of the membrane electrode units, effective humidification of the ionomer in the catalyst layers and the membrane, and a fast removal of the reaction product (water) from the cathode side of the membrane electrode assemblies.

Commercially available large-pore carbon fiber materials having a porosity of from 50% to 95% can be used for the manufacture of the gas distribution layers of the invention herein. There are various basic materials that are different from each other regarding structure, manufacturing process and properties. Examples of such materials are SIGRACET GDL 10-P by SGL Carbon Group or Panex 33 CP by Zoltek, Inc.

Commercially available large-pore carbon fiber materials can be impregnated with a hydrophobic polymer before use. Suitable hydrophobic polymers include, for example, polyethylene, polypropylene, polytetrafluoroethylene or other organic or inorganic hydrophobic materials. Preferably used for impregnation are suspensions of polytetrafluoroethylene or polypropylene. Depending on the purpose of use, the carbon fiber substrates may be coated with a hydrophobic polymer in an amount ranging between 3% and 25% (by weight). Coating amounts between 4% and 20% (by weight) have been found to be effective. In doing so, the coating weight of the gas distribution layers of the anode and cathode may be different. The impregnated carbon fiber substrates are dried at temperatures of up to 250° C., while the air is exchanged rapidly. Particularly preferably the material is dried in a circulating air dryer at 60° C. to 220° C., preferably at 80° C. to 140° C. The hydrophobic polymer is sintered during a subsequent calcination step. In the case of PTFE the selected temperature is from 330° C. to 400° C.

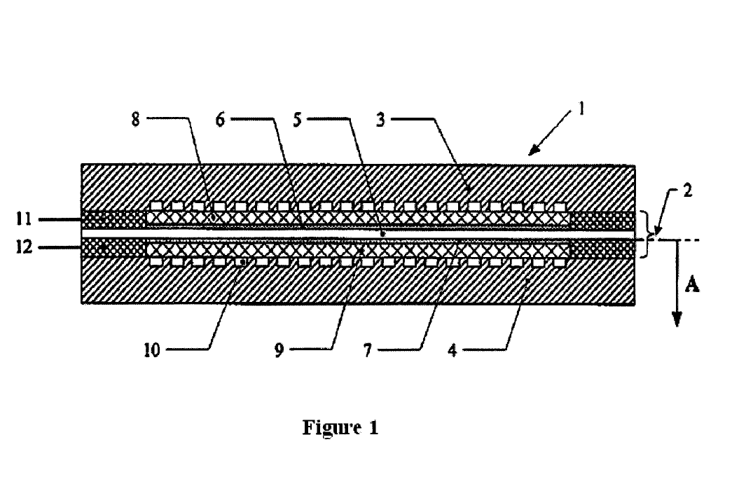

FIG. 1 shows a cross-section of a PEM fuel cell stack (1), which, for the sake of clarity, contains only one membrane electrode assembly (2). Further, there is polymer electrolyte membrane (5), which is in contact on both its sides with a reaction layer or a catalyst layer ((6) and (7)). The area covered by the catalyst layers is smaller than that of the membrane, so that the polymer electrolyte membrane extends on all sides beyond the catalyst layers and thus forms a coating-free border. One compressible large-pore gas distribution layer (8, 9) of carbon fiber material is arranged between each reaction layer and the adjacent bipolar layers, whereby said carbon fiber material is arranged essentially congruent with said reaction layers. “Essentially congruent” in this context means that the gas distribution layers are the same size or slightly larger than their associate reaction layers. The lateral dimensions of the gas distribution layers may exceed those of the reaction layers by 1 mm to 2 mm. The bipolar plates (3, 4) having the gas distribution channels (10) are placed on both sides of the gas distribution layers. The gaskets (11 and 12) having a central cutout are provided in order to seal the membrane electrode assembly consisting of the polymer electrolyte membrane, catalyst layers and gas distribution layers. The central cutout of the gaskets is adapted to the lateral dimensions of the gas distribution layers.

Preferably used gaskets (11 and 12) are incompressible polymer films or polymer composite films such as, for example, glass-fiber reinforced PTFE films. During the assembly of the fuel cell stack the entire stack is compressed perpendicular to the polymer electrolyte membrane with the use of a screwing method. Therefore, the overall thickness of the gasket films is selected in such a manner that, following assembly, the compressible gas diffusion electrodes consisting of reaction layers and gas distribution layers are available in the desired degree of compression.

By adjusting specific gasket thicknesses, several gasket films, each having a different thickness, may be used. In conjunction with this, it is also possible to use various overall thicknesses on the anode and cathode sides (D_{A}, D_{C}). Due to the elasticity of the membrane, an average compression factor k=(D_{A}+D_{C})/2·D₁ is obtained.

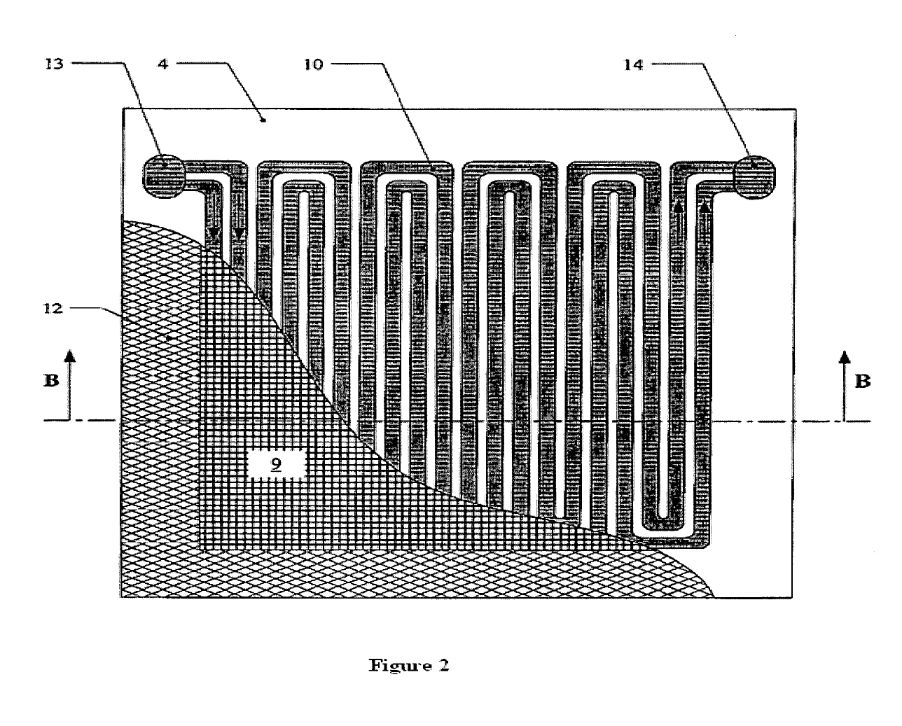

FIG. 2 shows a plan view of the bipolar plate (4) in accordance with FIG. 1, View A, with superimposed gas distribution layer (9) and gasket (12). The gas distribution layer (9) and the gasket (12) are drawn only partially in this plan view and permit a view of the channel structure of the bipolar plate. The gas distribution channels (10) are arranged in a serpentine structure and connect the supply channel (13) with the drainage channel (14), both of which extend in perpendicular direction through the cell stack. The cross-section of the PEM fuel cell stack in accordance with FIG. 1 corresponds to Section B-B of FIG. 2.

In a preferred embodiment, the invention comprises a PEM fuel cell stack wherein the gas distribution layer and adjacent reaction layer are compressed to thickness D2.

In another preferred embodiment, the invention comprises a PEM fuel cell stack wherein the porosity of the gas distribution layer is reduced by compression to 50% to 85% of its original porosity.

In yet another preferred embodiment, the invention comprises a PEM fuel cell wherein the gasket is composed of incompressible material.

In yet another preferred embodiment, the invention comprises a PEM fuel cell wherein the gasket has an anode side and a cathode side and comprises a thickness DA on the respective anode side and a thickness D_{C} on the respective cathode side, and that a compression factor k of the gas diffusion electrode is expressed in terms of k=(D_{A}+D_{C})/2D₁.

The inventive fuel cells, fuel cell stacks, and method of making a fuel cell stack can be employed in an electrically powered vehicle, for example an automobile, having a fuel cell unit for the supply of electrical energy.

Having now generally described the invention, the same may be more readily understood through the following reference to the following examples, which are provided by way of illustration and are not intended to limit the present invention unless specified.

### EXAMPLES

The following Examples and Reference Examples are intended to provide a detailed explanation of the present invention to those skilled in the art.

### Reference Example 1

This example describes a non inventive form of embodiment which uses a gas distribution substrate with a carbon/PTFE micro layer.

A piece of carbon fiber material of the type SIGRACET GDL 10 by SGL Carbon Group having a weight of 115 g/m² and a thickness of 380 μm was immersed in a suspension of PTFE (polytetrafluoroethylene) and water (Hostaflon TP5235, Dyneon GmbH). After a few seconds the material was removed. After draining the superficially adhering suspension, the carbon fiber fleece material was dried in a circulating air dryer at 110° C. In order to fuse the PTFE introduced into the structure of the carbon fiber material, it was calcinated at 340° C. to 350° C. for approximately 15 minutes in a chamber furnace.

Thereafter, these pieces of carbon fiber materials were coated with a paste of Vulcan XC-72 carbon and PTFE, dried and again calcinated. The ratio of carbon to PTFE was 7:3. The total loading of the dried and calcinated paste was 3.2±0.2 mg/cm²

The mean thickness of the finished carbon fiber pieces was 400 μm.

These anode and cathode gas distribution layers were incorporated, together with a membrane electrode assembly, in a fuel cell test cell with serpentine structure. During the assembly of the test cell, the bipolar plates were screwed to each other at an angular momentum of 8 Nm until the gas distribution layers, including the respective catalyst layer, were compressed to the thickness of the gaskets.

The gaskets used were several chem-glass gaskets (incompressible, glass-fiber reinforced PTFE) having a total thickness of 0.50 mm (anode and cathode: 1×0.25 mm each). Together with the thickness of the respective catalyst layer of 25 μm, this results in a calculated compression of the gas diffusion electrodes to 58.8% of the original thickness (k=0.588).

The catalyst-coated membrane used here was produced in accordance with U.S. Pat. No. 6,309,772, Example 3, Ink A. The catalysts used were 40% (by weight) of Pt on Vulcan XC72 for the cathode side and 40% (by weight) of PtRu (1:1) on Vulcan XC72 on the anode side. The ratio of catalyst to ionomer was 3:1.

The polymer electrolyte membrane and the ionomer for the reaction layers were used in their non-acidic form and, after completion of the production process, sulfuric acid was used to convert them again into their acidic proton-carrying modification.

In order to form the cathode layer, the cathode ink was printed in its Na⁺ form by screen-printing technique on a Nafion® 112-Membrane (thickness, 50 μm) and dried at 90° C. Thereafter, the reverse side of the membrane was coated with the anode ink in the same manner in order to form the anode layer. Protonation takes place in 0.5 M sulfuric acid. The platinum loading of the cathode layer was 0.4 mg Pt/cm² and that of the anode layer was 0.3 mg Pt/cm². This corresponded to a total platinum loading of the coated membrane of 0.7 mg/cm². The layer thicknesses ranged between 15 and 20 μm. The printed area was 50 cm² in each case.

### Reference Example 2

This Example describes a non inventive form of embodiment with the use of a gas distribution substrate with a carbon/PTFE micro layer.

All the steps of treatment carried out with the carbon fiber material of the type SIGRACET GDL 10 by SGL Group were analogous to Reference Example 1. The gas distribution layers treated in this manner were incorporated, together with a catalyst-coated membrane corresponding to Reference Example 1, in a fuel cell test cell with serpentine structure. During assembly of the test cell, the bipolar plates were screwed together at an angular momentum of 8 Nm until the gas distribution layers, including the respective catalyst layer, were compressed to the thickness of the gaskets.

The gaskets used were several chem-glass gaskets (incompressible, glass-fiber reinforced PTFE) having a total thickness of 0.60 mm (anode: 2×0.15 mm; cathode: 1×0.25 mm+1×0.05 mm). Together with the thickness of the respective catalyst layer of 25 μm, this results in a calculated compression of the gas diffusion electrodes to 70.6% of the original thickness (k=0.706).

### Reference Example 3

This Example describes a form of embodiment with the use of gas diffusion electrodes without a carbon/PTFE micro layer, however, with a compression factor k above the inventive range (minimal compression).

A piece of carbon fiber material of the type SIGRACET GDL 10 by SGL Carbon Group having a weight of 115 g/m² and a thickness of 400 μm was immersed in a suspension of PTFE (polytetrafluoroethylene) and water (Hostaflon TP5235, Dyneon GmbH). After a few seconds the material was removed. After draining the superficially adhering suspension, the carbon fiber material was dried in a circulating air dryer at 110° C. In order to fuse the PTFE introduced into the structure of the carbon fiber material, it was calcinated at 340° C. to 350° C. for approximately 15 minutes in a chamber furnace.

The mean thickness of the finished carbon fiber pieces was 400 μm.

All of these gas distribution layers were incorporated, together with a catalyst-coated membrane corresponding to Reference Example 1, in a fuel cell test cell with serpentine structure. During assembly of the test cell, the bipolar plates were screwed together at an angular momentum of 8 Nm until the gas distribution layers, including the respective catalyst layer (=reaction layer), were compressed to the thickness of the gaskets.

The gaskets used were several chem-glass gaskets (incompressible, glass-fiber reinforced PTFE) having a total thickness of 0.84 mm (anode: 1×0.32 mm+1×0.2; cathode: 1×0.32 mm). Together with the thickness of the respective catalyst layer of 25 μm, this results in a calculated compression of the gas diffusion electrodes to 98.8% of the original thickness (k=0.988).

### Reference Example 4

Reference Example 3 was repeated, however, in this example the thickness of the gaskets was reduced to a value of 0.35 mm (anode: 1×0.15 mm; cathode: 1×0.2 mm).

During assembly of the test cell, the bipolar plates were screwed together at an angular momentum of 8 Nm until the gas distribution layers, including the respective catalyst layer, was compressed to the thickness of the gaskets. Together with the thickness of the respective catalyst layer of 25 μm, this results in a calculated compression of the gas diffusion electrodes to 41.7% of the original thickness (k=0.417).

### Example 1

All the steps of treatment carried out with the carbon fiber materials of the type SIGRACET GDL 10 by SGL Group were analogous to Reference Example 3. These anode and cathode gas distribution layers were incorporated, together with a catalyst-coated membrane corresponding to Reference Example 1, in a fuel cell test cell with serpentine structure. During assembly of the test cell, the bipolar plates were screwed together at an angular momentum of 8 Nm until the gas distribution layers, including the respective catalyst layer, were compressed to the thickness of the gaskets.

The gaskets used were several chem-glass gaskets (incompressible, glass-fiber reinforced PTFE) having a total thickness of 0.7 mm (anode: 2×0.15 mm; cathode: 2×0.2 mm). Together with the thickness of the respective catalyst layer of 25 μm, this results in a calculated compression of the gas diffusion electrodes to 82.3% of the original thickness (k=0.823).

### Example 2

All the steps of treatment carried out with the carbon fiber materials of the type SIGRACET GDL 10 by SGL Group were analogous to Reference Example 3. The gas distribution layers were incorporated, together with a catalyst-coated membrane corresponding to Reference Example 1, in a fuel cell test cell with serpentine structure. During assembly of the test cell, the bipolar plates were screwed together at an angular momentum of 8 Nm until the gas distribution layers, including the respective catalyst layer, were compressed to the thickness of the gaskets.

The gaskets used were several chem-glass gaskets (incompressible, glass-fiber reinforced PTFE) having a total thickness of 0.6 mm (anode: 1×0.25 mm; cathode: 1×0.35 mm). Together with the thickness of the respective catalyst layer of 25 μm, this results in a calculated compression of the gas diffusion electrodes to 71.4% of the original thickness (k=0.714).

### Example 3

All the steps of treatment carried out with the carbon fiber materials of the type SIGRACET GDL 10 by SGL Group were analogous to Reference Example 3. The gas distribution layers were incorporated, together with a catalyst-coated membrane corresponding to Reference Example 1, in a fuel cell test cell with serpentine structure. During assembly of the test cell, the bipolar plates were screwed together at an angular momentum of 8 Nm until the gas distribution layers, including the respective catalyst layer, were compressed to the thickness of the gaskets.

The gaskets used were several chem-glass gaskets (incompressible, glass-fiber reinforced PTFE) having a total thickness of 0.52 mm (anode: 1×0.2 mm; cathode: 1×0.32 mm). Together with the thickness of the respective catalyst layer of 25 μm, this results in a calculated compression of the gas diffusion electrodes to 61.2% of the original thickness (k=0.612).

Electrochemical Testing:

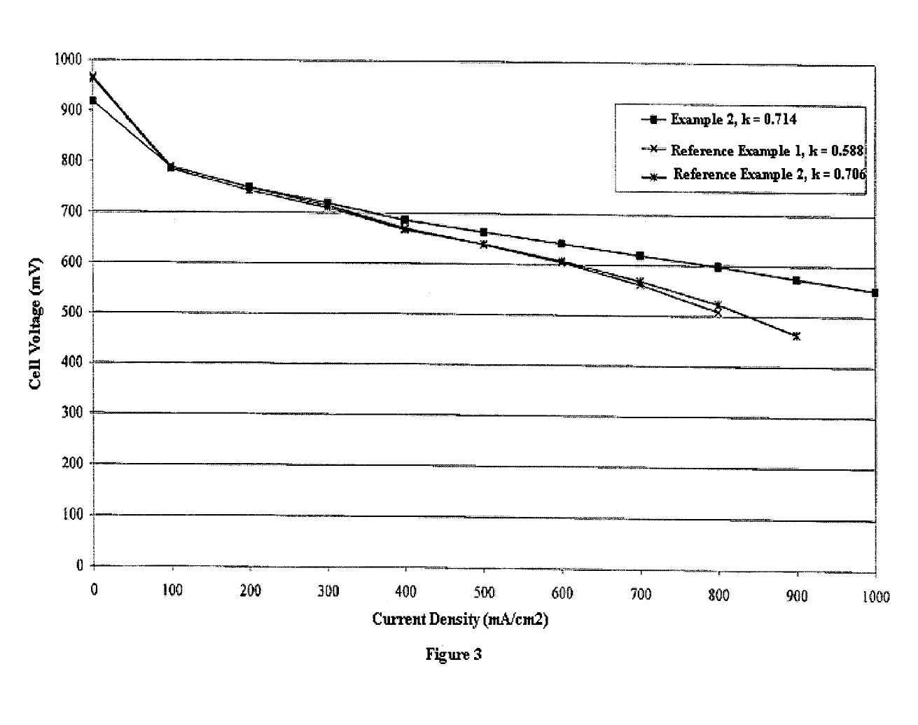

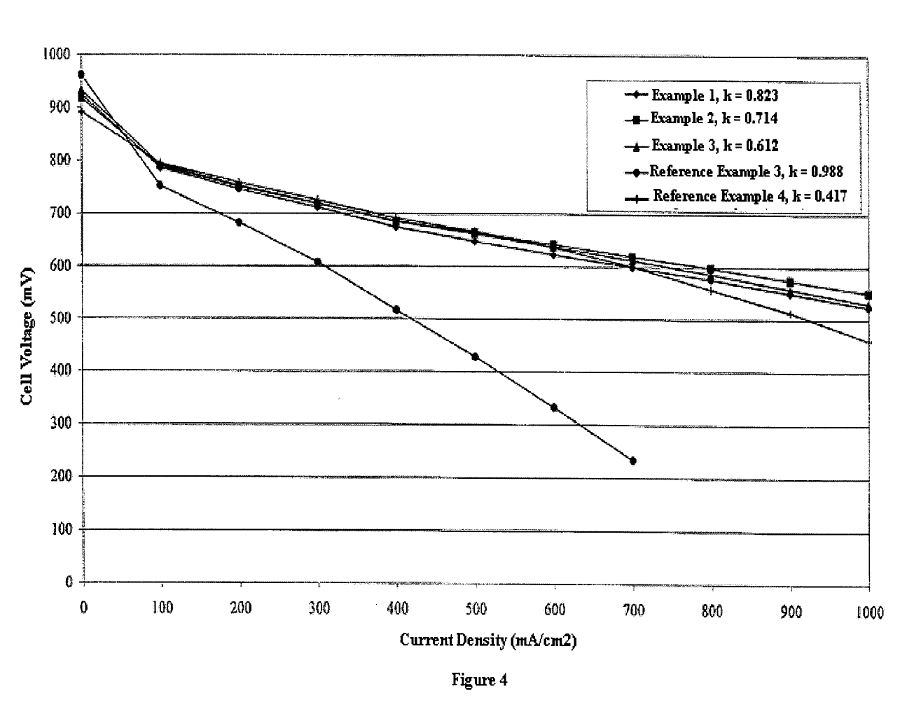

The measured voltages of the fuel cells in accordance with Reference Examples 1 and 2, as well as Example 2 during reformate/air operation are shown in FIG. 3 as a function of current density. FIG. 4 shows corresponding, measured results for the fuel cells of Reference Examples 3 and 4, and Examples 1 through 3. The cell temperature was 75° C. The operating pressure of the reactive gases was 1 bar. The hydrogen content of the reformate was 48% (by volume). The CO concentration was 50 ppm. In order to increase the performance of the fuel cell, 3% (by volume) of air were added to the anode gas.

FIG. 3 shows that the inventive fuel cell of Example 2 exhibits a clearly improved electrical performance with approximately the same compression factor as the fuel cell of Reference Example 2. The compression of a hydrophobic gas distribution layer without carbon/PTFE equalizing layer provides an improvement—compared with the illustrated waterproofed gas distribution layers having an equalizing layer—at different degrees of compression. In the case of these, stronger compression did not produce improved performance data.

Table 1 shows the cell voltages that could still be measured when a current density of 600 mA/cm² was applied to the cells.

TABLE 1
Cell voltages during reformer/air operation at 600 mA/cm²

| Example | Cell Voltage (mV) |
|---|---|
| Reference Example 1 | 605 |
| Reference Example 2 | 608 |
| Reference Example 3 | 332 |
| Reference Example 4 | 637 |
| Example 1 | 623 |
| Example 2 | 642 |
| Example 3 | 638 |

FIG. 4 shows the performance curves of Examples 1, 2 and 3, and Reference Examples 3 and 4. All hydrophobic gas distribution layers in these Examples were used without being coated with a micro layer. The degree of compression in these Examples and Reference Examples varies between 0.988 and 0.417. In the case of a high degree of compression of 0.988 (low compression) the cell voltage drops severely at high current densities due to poor contact between the reaction layers and the gas distribution layers. With increasing compression of the fuel cell stacks, the performance of the fuel cells drops initially. Very good performance values are obtained with a degree of compression between 0.823 and 0.612. The degree of compression providing the best performance characteristics is 0.714.

In the case of Reference Example 4 (compression to 41.7% of the original thickness, k=0.417), however, it must be noted that the open cell voltage drops below 900 mV, thereby indicating that leakage exists. In this case the fuel cell is compressed too much; the membrane was mechanically damaged by the fibers of the gas distribution layer. Also, in the range of high current densities starting at 700 mA/cm², the negative effect of excessive compression is evident. Gas diffusion is impaired. Performance decreases. If this fuel cell is operated for an extended period of time, there is the risk that formation of hot spots at the leakage sites can lead to the total failure of the fuel cell.

While the invention has been described in connection with specific embodiments thereof, it will be understood that it is capable of further modifications and this application is intended to cover any variations, uses, or adaptations of the invention following, in general, the principles of the invention and including such departure from the present disclosure as come within known or customary practice within the art to which the invention pertains and as may be applied to the essential features hereinbefore set forth and as follows in the scope of the appended claims.

What is claimed is:

1. A PEM fuel cell stack, having one or more superimposed fuel cells wherein each fuel cell comprises:
(a) a membrane electrode assembly having a polymer electrolyte membrane;
(b) a reaction layer on each side of the polymer electrolyte membrane, wherein each reaction layer covers a smaller area than the polymer electrolyte membrane;
(c) a compressible gas distribution layer of carbon fiber material adjacent to each reaction layer and substantially congruent thereto, wherein each gas distribution layer has a first side and a second side, and wherein the first side is in direct contact with the reaction layer;
(d) an electrically conductive bipolar plate adjacent to each second side of each gas distribution layer and each plate covering an area larger than the adjacent gas distribution layer; and,
(e) gaskets disposed between each bipolar plate and the polymer electrolyte membrane outside the area covered by the gas distribution layers; wherein gas diffusion electrodes formed by the reaction layers and the gas distribution layers exhibit a no-load thickness D1 and said gaskets exhibit a no-load thickness D2, and wherein the gas diffusion electrodes are compressed in the PEM fuel cell stack to 50 to 85% of their no-load thickness D1.

2. A fuel cell comprising:
(a) a polymer electrolyte membrane;
(b) a reaction layer on each side of the polymer electrolyte membrane, wherein each reaction layer has length and width dimensions smaller than those of the polymer electrolyte membrane;
(c) at least one compressible gas distribution layer of carbon fiber material adjacent to and substantially congruent with one of the reaction layers, wherein the gas distribution layer has a first face and a second face and wherein the first face of the gas distribution layer is in direct contact with the adjacent reaction layer;
(d) at least one electrically conductive bipolar plate in direct contact with the second face of the gas distribution layer; and
(e) a gasket having a thickness D2 and disposed between the bipolar plate and the polymer electrolyte membrane;
wherein the gas distribution layer and the adjacent reaction layer together have a no-load thickness of D1 and are capable of being compressed to thickness D2 and D2 is 50% to 85% of D1.

3. A PEM fuel cell stack comprising the fuel cell of claim 2, wherein the gas distribution layer and adjacent reaction layer are compressed to thickness D2.

4. A PEM fuel cell stack according to claim 3, wherein the porosity of the gas distribution layer is reduced by compression to 50% to 85% of its original porosity.

5. A fuel cell according to claim 2, wherein the gaskets are composed of incompressible material.

6. A fuel cell according to claim 5, wherein the gasket has an anode side and a cathode side and comprises a thickness DA on the respective anode side and a thickness DC on the respective cathode side, wherein a compression factor k of the gas diffusion electrode is expressed in terms of k=(D_{A}+D_{C})/2D₁.

7. A method of making a fuel cell stack using fuel cells according to claim 5, comprised of:
stacking the fuel cells; and
compressing the gas diffusion electrodes in the fuel cell stack to the thickness of the gaskets.

8. A method of making a fuel cell stack using fuel cells according to claim 6, comprised of:
stacking the fuel cells; and
compressing the gas diffusion electrodes in the fuel cell stack to the thickness of the gaskets.

9. A method of making a fuel cell stack using fuel cells according to claim 6, comprised of:
stacking the fuel cells; and
compressing the gas diffusion electrodes in the fuel cell stack with a compression factor K of 0.5 to 0.85.

10. A gas distribution layer for PEM fuel cell stacks, comprised of:
a gas distribution layer having a compressible carbon fiber material that is compressed in the fuel cell stack to 50% to 85% of its original thickness.

11. An electrically powered automobile having a fuel cell unit for the supply of electrical energy, comprised of:
a fuel cell unit comprising a PEM fuel cell stack according to claim 1.

12. An electrically powered automobile having a fuel cell unit for the supply of electrical energy, comprised of:
a fuel cell unit comprising a PEM fuel cell stack having fuel cells according to claim 2.

13. An electrically powered automobile having a fuel cell unit for the supply of electrical energy, comprised of:
a fuel cell unit comprising a PEM fuel cell stack according to claim 3.

14. An electrically powered automobile having a fuel cell unit for the supply of electrical energy, comprised of:
a fuel cell unit comprising a PEM fuel cell stack according to claim 4.

15. A combined heat and power supply for residential houses having a fuel cell unit for the supply of electrical energy and heat, comprised of:
a fuel cell unit comprising a PEM fuel cell stack according to claim 1.

16. A combined heat and power supply for residential houses, having a fuel cell unit for the supply of electrical energy and heat, comprised of:
a fuel cell unit comprising a PEM fuel cell stack having fuel cells according to claim 2.
